(19) United States
(12) Patent Application Publication
(10) Pub. No.: US 2005/0272429 A1
(43) Pub. Date: Dec. 8, 2005

(54) Approximating cell geometry in a cellular transmission system

(76) Inventors: Rod Walsh, Tampere (FI); Juha-Pekka Luoma, Tampere (FI)

Correspondence Address: MORGAN & FINNEGAN, L.L.P., 3 WORLD FINANCIAL CENTER, NEW YORK, NY, 10281-2101, US

(21) Appl. No.: 10/517,965

(22) PCT Filed: Jun. 28, 2002
(86) PCT No.: PCT/IB02/02500

§ 371 Date: Jul. 12, 2005

(51) Int. Cl. H04Q 7/20

(52) U.S. Cl. 455/443; 455/432.1

(57) ABSTRACT

Approximating cell geometry in a cellular transmission system User equipment (UE1) for use in a cellular transmission system comprising a processor configuration (6) to provide data corresponding to first and second parameters (a, b) for dimensional extents of the cell, and to select one of a plurality of different approximate geometrical configurations for the cell in dependence on the relationship between the values of said parameters. The selected cell approximation is then compared with the UE's current location to determine if a cell handover is to be made. The cell approximation technique is described in relation to a DVB-T network.

### FIELD OF THE INVENTION

This invention relates to a method of approximating cell geometry in a cellular transmission system and particularly but not exclusively to improving cell handovers.

### BACKGROUND

Cell handovers occur between cells in a wireless mobile communications network when user equipment (UE) moves from the coverage area of one cell to another. It involves setting up new connections and releasing or maintaining old connections to network cells as the user equipment (UE) moves from the coverage area of one cell to another. Typically, the coverage area of neighbouring cells overlap, which leads to the possibility of maintaining multiple cell connections and handing over by increasing, reducing or maintaining the number of UE-network cell connections. In 3G systems, “soft-handover” uses this technique.

Handover in wireless cellular systems is normally a three-phase process: (1) measurement—measurement criteria, measurement reports; (2) handover decision—algorithm parameters, handover criteria; and (3) execution—handover signalling, radio resource allocation. As an example, measurement may be on a near continuous basis e.g. sampled every 100 ms, the decision is assessed regularly e.g. every 5 seconds and handover is infrequent, depending on the UE usage, e.g. on average every 20 minutes.

Handover execution is typically initiated as a result of a decision based on the measurement of certain criteria e.g. signal quality between a base station (BS) for the cell concerned and the UE. There are circumstances where the measurement process may take considerable time or may not be feasible while receiving a service over a current connection. This may cause delays in data flow and result in lost data due to the handover process. An example is in terrestrial video broadcasting (DVB-T) systems, where a typical terminal has only one DVB receiver front-end, which is not capable of multiplexed scanning between the transmissions of adjacent cells whilst concurrently receiving a DVB transmission, and so would have to temporarily cut the connection to the current service to perform a multi-frequency scan for radio bearers and interrogate control signalling on each available bearer signal to determine if adjacent cells are suitable candidates for a handover.

A simple method to enable faster discovery of co-located and adjacent cells is for a UE to discover some of the connection parameters for those cells in advance of physical measurement and data parsing of the cells concerned. For example, DVB describes a Network Information Table (NIT), which may define all the cells in a DVB network and includes data corresponding to their frequencies and cell geography. The cells are defined as a rectangle projected onto the spherical surface of the Earth, and the cell descriptors include cell id, cell latitude, cell longitude, cell extent of latitude and cell extent of longitude. The cell latitude and longitude may define the southwest corner of the rectangular cell and the extents of latitude and longitude define the lengths of side edges of the rectangle extending from the southwest cell corner.

A problem with this configuration is that the rectangular definition of the cell is a poor approximation of its actual transmission coverage area, which degrades the handover process.

### SUMMARY OF THE INVENTION

According to the invention there is provided user equipment for use in a cellular transmission system, comprising a processor configuration to provide data corresponding to first and second circular parameters for the dimensional extent of at least one cell of the system.

The processor configuration may operable to provide the data as a function of major and minor axial extents of an ellipse and the data may correspond to characteristics of relatively large and small circles, which may be concentric. Furthermore, the processor configuration may be operable to provide data corresponding to the centers of the circles.

The processor may be operable to select one of a plurality of different approximate geometrical configurations for the cell in dependence on the relationship between the values of said parameters.

The user equipment may be supplied with information corresponding to a rectangular approximation of the cell, such as DVB-T NIT information and the processor configuration may operable to convert information into said data. This may involve converting the NIT information into a Cartesian reference frame.

The user equipment may comprise a mobile device operable to receive DVB transmissions and may be further operable as telecommunications apparatus.

Circuitry to provide data corresponding to the current location of the user equipment may be provided, which may be compared with the data corresponding to the cell for determining whether a cell handover is to be carried out.

The invention further provides user equipment for use in a cellular transmission system, comprising a processor configuration to provide data corresponding to first and second parameters for dimensional extents of the cell, and to select one of a plurality of different approximate geometrical configurations for the cell in dependence on the relationship between the values of said parameters.

The invention also includes a corresponding method, and a network that makes use of the inventive method.

The invention improves the accuracy of cell approximation and also provides an arrangement which improves the cell handover process.

### BRIEF DESCRIPTION OF THE DRAWINGS

In order that the invention may be more fully understood an embodiment thereof will now be described with reference to the accompanying drawings in which:

FIG. 1 is a schematic block diagram of a mobile network;

FIG. 2 is a schematic block diagram of a UE for use in the network of FIG. 1;

FIG. 3 is an illustration of a cell coverage area with a rectangular and elliptical cell approximation;

FIG. 4 illustrates the elliptical cell approximation for an originating cell and a target cell;

FIGS. 5a and 5b illustrate different elliptical configurations in which the large circle and the small circle or the rectangle constitute a better match for the cell concerned;

FIG. 6 is a flow diagram for a handover process performed by the UE;

FIG. 7 is a more detailed block diagram of the cell model selection; and

FIG. 8 is a more detailed block diagram of the process for determining whether the UE is within the coverage area of the target cell.

### DETAILED DESCRIPTION

System Overview

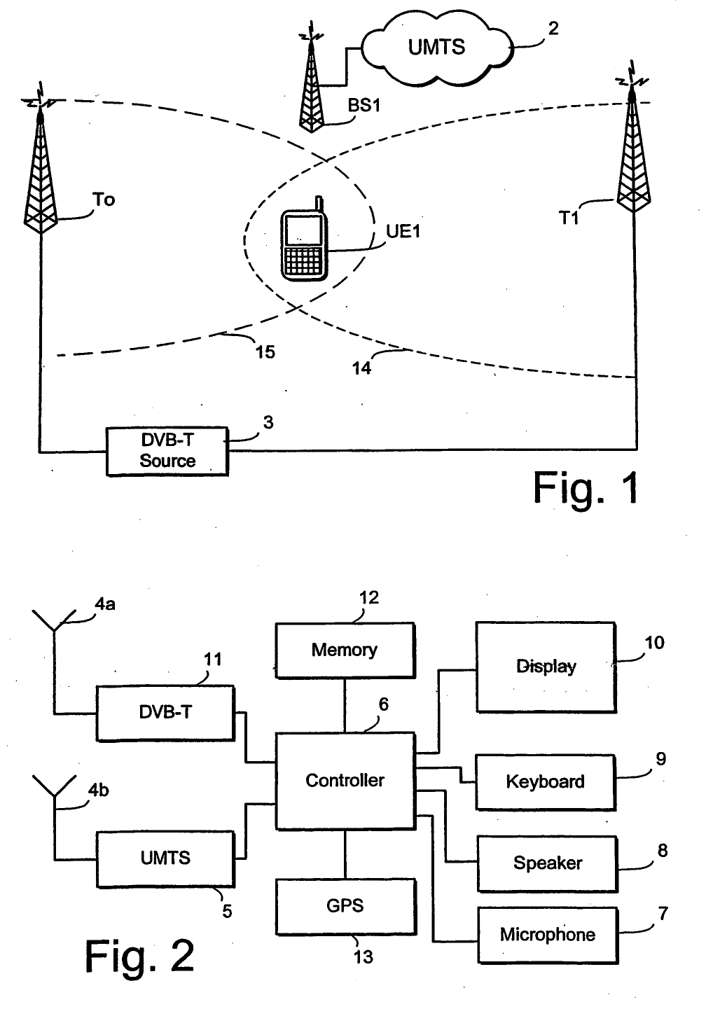

In the following description, the invention is described by of example with reference to a DVB-T network although as will be evident hereinafter it can be applied to any cellular network. Referring to FIG. 1, UE1 is a dual mode mobile device for use with a UMTS telecommunications network and the DVB-T network. The UMTS network includes a base station BS1 connected to a land network 2, although in practice, the UMTS network will include many base stations and only one is shown in order to simplify the drawing. The UMTS network provides cellular voice and IP data communication with UE1 in a manner known per se.

The DVB-T network includes geographically spaced apart base stations T0 and T1 that may be connected in a network to a content source 3 shown schematically that can supply UE1 with video streaming or other data. The data received through the DVB network may be used in conjunction with services provided through the UMTS network. The network may include more than the two base stations shown in FIG. 1 and each of them provides a cellular area of coverage. Furthermore, each base station may support one or more cells and each cell may be supported by more than one base station (not shown in the figure).

The device UE1 may be configured in a number of different forms as already proposed in the art.

In this example, UE1 comprises a combined mobile telephone handset and personal digital assistant (PDA). A schematic block diagram of the UE1 is shown in FIG. 2. For UMTS operation, the device includes an antenna 4a coupled to UMTS transceiver circuits 5 that are coupled to a controller 6 that comprises a digital processor. Bi-directional voice and data communication can be performed through the UMTS network. More particularly, voice signals for transmission can be developed through microphone 7 and received audio signals can be fed to a loudspeaker or earpiece 8. Telephony dialling and data manipulation can be carried out by means of a keyboard 9 or other communication interface like voice response unit (not shown). Data can be displayed on a display device 10, which may be a LCD.

Also, data from the DVB network may be transmitted to on a downlink UE1 and received by antenna 4b, parsed by DVB-T circuits 11 and fed to controller 6 for display on the display device 10. Audio signals from the DVB transmission may be fed to the loudspeaker 8. The DVB system may also have a relatively narrow band uplink channel and data may transmitted through the circuits 11 and antenna 4b to one of the DVB base stations T0, T1. The controller 6 has an associated data store 12 which may comprise an EEPROM that can store the previously discussed DVB NIT data concerning the cell geography, when transmitted on the downlink.

The UE1 may also include satellite global positioning (GPS) circuitry 13 coupled to the controller 6, in order to determine its latitude and longitude using signals from GPS satellites

Each of the DVB base stations T0, T1 has a transmission range 14, 15 shown schematically in FIG. 1, of the order of 20-60 km and their coverage areas partially overlap. In this example, UE1 is in communication with the DVB cell provided by base station T0 and is in the area of overlap with the cell of base station T1, and so it may be desirable to make a cell handover.

Elliptical Cell Approximation

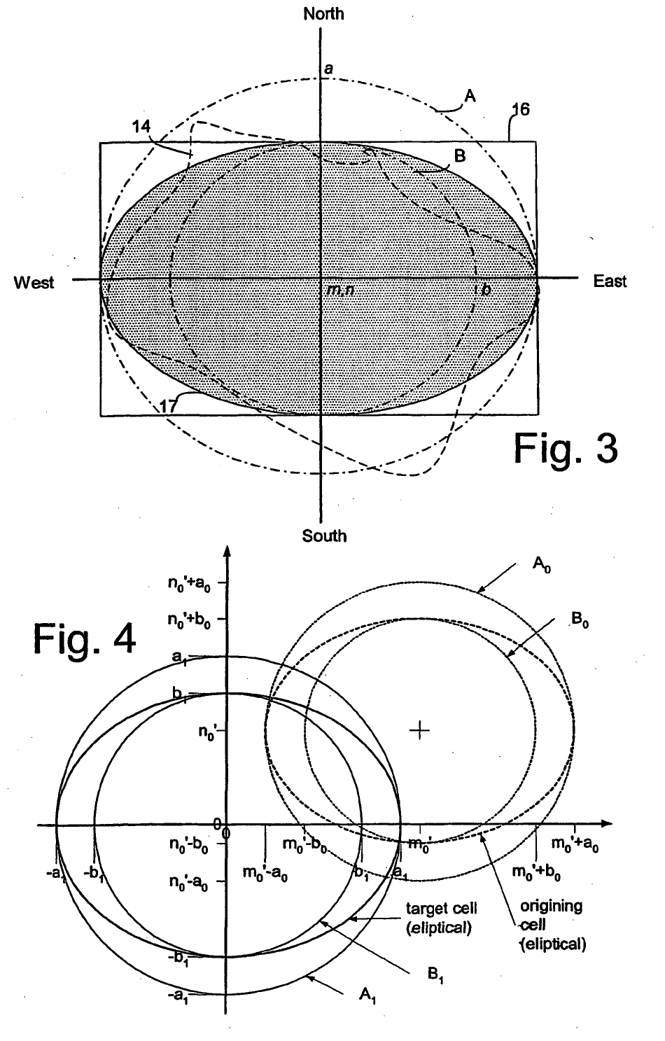

The shape of the cell coverage areas will now be considered in more detail with reference to FIG. 3. Although in theory the coverage area of a cell is circular, in practice it is of a non-regular shape, caused by hills, buildings and other obstructions within the vicinity of the base station antenna. This is illustrated schematically in hatched outline 14 for the cell provided by base station T0. A corresponding rectangular cell approximation 16 is shown, which may correspond to the conventional NIT data for the cell concerned.

In accordance with an embodiment of the invention it has been appreciated that using circular parameters and considering the cell in terms of an ellipse 17 can achieve a better approximation. In many circumstances, an ellipse can provide a better fit to the actual cell geometry than a rectangle, as shown in FIG. 3. However, when considering a cell handover in terms of overlapping elliptical cells, the mathematics involved for computing overlying ellipses is much more complicated than for rectangular cell approximations and may not be suitable for a mobile UE with limited processing power. In accordance with an embodiment of the invention, an improved simplification for an elliptical cell has been devised. The ellipse 17 is characterised in terms of a large circle A of radius a drawn on its major axis and a small circle B of radius b drawn on its minor axis, the circles being concentric in this example and centered on a point m, n in a Cartesian reference frame originating at 0,0 latitude and longitude. Thus, the cell can be defined in the following notation: {m, n, a, b}.

This nomenclature is developed in FIG. 4 for two cells labelled 0 and 1 for a situation when a handover is to be considered, i.e. from cell 0 referred to as the originating cell, to cell 1, referred to as a target cell, i.e. from cell {m₀, n₀, a₀, b₀} to cell {m₁, n₁, a₁, b₁}. In FIG. 4, the notation is simplified by centering the co-ordinate system on the target cell i.e. target cell′={0,0,a₁, b₁} and originating cell′={m₀-m₁, n₀-n₁, a₀, b₀}={m₀′, n₀′, a₁, b₀}. (The ′ symbol is used to denote this simplification).

Best Fit

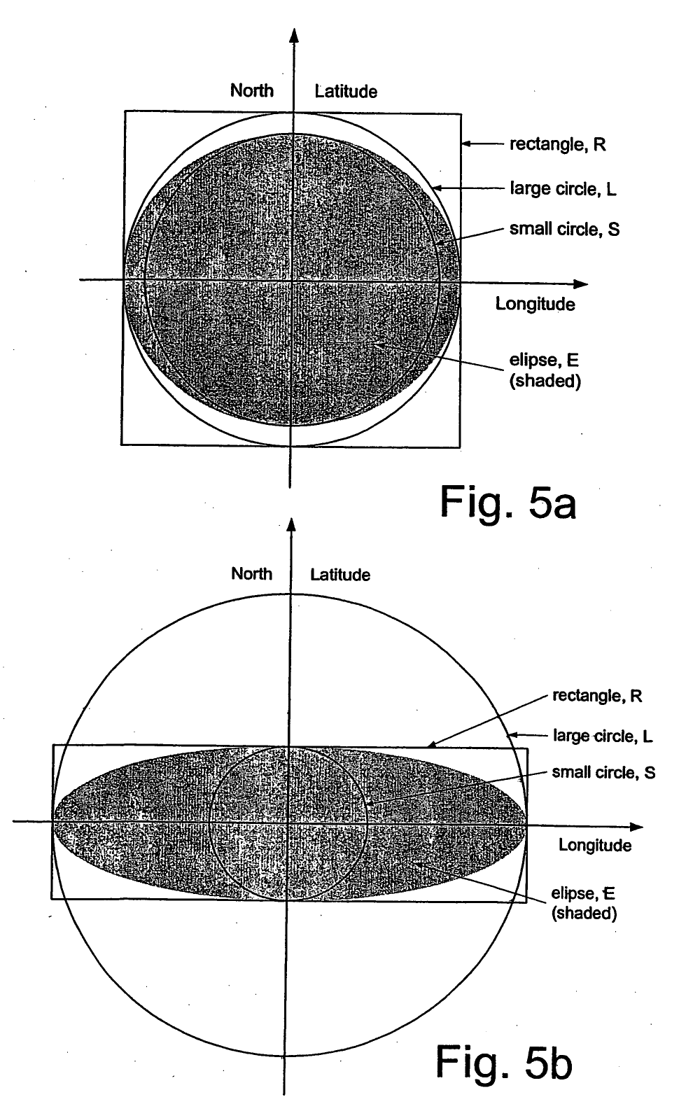

In accordance an embodiment with the invention, the cell approximation for an individual cell may be selected on the basis of an individual one of the circles of radius a, b or on the basis of a rectangle of dimensions 2a, 2b, the choice being made on the basis of which is the best fit for the cell concerned. The best fitting cell geometry approximation can be determined by an analysis of the relationship of the dimensional parameters a and b. This can be seen in general terms from FIGS. 5a and 5b. The ellipse of FIG. 5a is better approximated by one of the circles A, B whereas in FIG. 5b, the cell is better approximated by the rectangle 16. A more formal mathematical analysis will now be given. Hereinafter, the larger circle A=L, the smaller circle B=S, the ellipse 17 is referenced E and the rectangle 16 is referenced R.

When the Rectangle R is a Worse Match than the Larger Circle L

From FIGS. 5a and 5b, it can be seen that L is sometimes a better match to the ellipse E than the rectangle R and sometimes worse. In general, the smaller the ratio of the radii (a/b), the better L matches than R. Based on the premise that both L and R completely contain the ellipse, it is possible to calculate the ratio at which they are an equal match as the areas will be equal.

Assuming a>b.

Circle area=π.a.a (π˜3.142)

Rectangle area=2a.2b

Thus 2a.2b=π.a.a, and b/a=π/4˜0.7854

Removing the assumption that a>b, either b/a=π/4 or a/b=π/4

So the larger circle L is a better match when b is between 78.5% and 121.5% of a.

When the Rectangle R is a Worse Match than the Smaller Circle S

Also, as a/b becomes larger, R will become a better match than the smaller circle S. This point can be found when the area of R that is not in the ellipse E, is equal to the area of the ellipse that is not in S.

Two ways to represent this are in terms of

(i) absolute areas and (ii) percentage of areas:

Considering the areas of the rectangle R, the ellipse E and the smaller circle S:

area(R)=2a.2b=4a.b

area(E)=π.a.b

area(S)=π.b.b (assuming a>b)

(i) Considering the aforementioned equality in terms of absolute areas:

area(R)−area(E)=area(E)−area(S)

i.e. 4a.b−π.a.b=π.a.b−π.b.b

a.b.(4−2π)=−ππ.b.b

a/b.(4/π−2)=−1 (dividing by π.b.b)

a/b=1/(2−4/π)˜b 1.3760

Removing the assumption that a>=b, either b/a or a/b=1/(2−4/π)

So, on the basis of absolute area, the smaller circle S is a better match than the rectangle R when b is between 62.4% and 137.6% of a.

(ii) Considering the aforementioned equality in terms of ratio of areas:

(area(E)/area(R))=(area(S)/area(E))

(π.a.b)/(4.a.b)=(π.b.b)/(π.a.b)

π/4=b/a 4˜0.7854

Removing the assumption that a>b, either b/a π/4 or a/b=π/4

So, for area ratios, the smaller circle S is a better match when b is between 78.5% and 121.5% of a. This is the same result as for L and so can be used to simplify the number of comparisons needed to determine the best fit.

From the foregoing, it will be understood that the ellipse model for the radio cell can be approximated according to a number of different options, as follows:

1. Approximation to a Small Circle and a Large Circle

The smaller circle S is completely within the ellipse E and the large circle L completely contains the ellipse. Thus, being within the coverage area of the smaller circle guarantees that the UE in the cell coverage, and being outside the coverage area of the larger circle guarantees that the UE is outside the cell coverage. The third possibility, that the UE fits the larger but not the smaller area, provide a “maybe in cell coverage” alternative, which may be employed.
   2. Approximation to a Small Circle and a Large Rectangle
This is an optimization of the previous alternative where a rectangle provides a better match than the larger circle. A new term, L′, in introduced so that L′=R in this alternative and L′=L in the previous option. Otherwise, the idea is the same as the previous option.
   3. Approximation to a Circle
This is effective when radius a is very similar to radius b. Can be thought of as a sub-type of the first option where L=S.
   Cell Handover

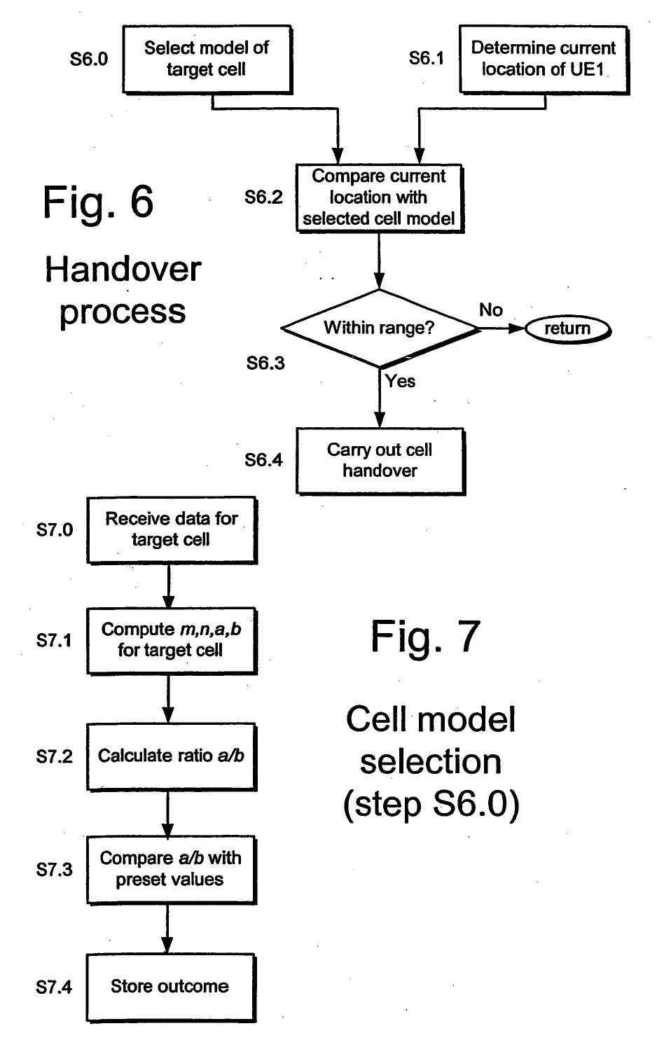

The general process for achieving a cell handover is shown in FIG. 6. At step S6.0 a selection of a model of the target cell is made. This process selects which of the cell approximation options listed above is to be used.

At step S6.1, the current location of UE1 is determined. This current location is compared with the selected cell model at step S6.2 and if this indicates that the UE is within the operational range (step S6.3) of the target cell, the handover process is carried out at step S6.4.

Features of this overall process will now be described in more detail.

Cell Model Selection (Step S6.0)

The process for selecting the cell model (step S6.0) for use in the handover may be performed at the UE by means of the controller 6 and is shown schematically in FIG. 7. At step S7.0, the UE receives data concerning the target cell. This may comprise NIT data in a DVB-T network. As previously discussed, the rectangular cell data comprises the latitude and longitude of a corner of the rectangular cell, and the latitudinal and longitudinal extents of the cell.

These data are at step S7.1 converted by simple trigonometry out of the angular, latitudinal and longitudinal frame and manipulated to provide the parameters m, n corresponding to the center of the rectangular cell in a Cartesian reference frame, and also the dimensional parameters a, b. It will be understood that the radii a and b for the cell when approximated as the ellipse correspond to half the latitudinal and longitudinal extents of the cell in the NIT cell data when converted into the Cartesian reference frame.

At step S7.2, the ratio a/b is computed. At step S7.3 a determination is made of whether R or L is a better match for the cell concerned. From the foregoing, it will be understood that L is better match if 0.785<a/b>1.215. Also, if a/b≈1, the circle approximation may be used (option 3). At step S6.4 the data concerning the better match is stored for future use i.e. L′=R or L.

Collecting Location Information (Step S6.1)

As previously explained, the UE needs information about its current location so that this can be compared with the selected approximation of the cell coverage area of the target cell in order to determine whether the UE is within the target cell. The obtaining of the current location information of the UE is shown at step S6.1 in FIG. 6 and will now be discussed in more detail.

Four scenarios are possible depending on how much detail the UE has on its current location:

1. The UE knows its current location exactly and uses this (“exactly” includes some negligible tolerance error)

2. The UE knows its current location approximately and uses this (tolerance is non-negligible)

3. The UE approximates its current location to that of the center of the originating cell

4. The UE approximates its current location to the area of the originating cell

It is evident that cases 1 and 3 are similar and cases 2 and 4 are similar. Cases 1 and 3 shall be known as the “point” case and 2 and 4 shall be known as the “area” case. Also, there are two sub-cases for the area case where:

a. it is sufficient to know that a target cell overlaps with some of the originating cell (so that a list of “potentially” available cells can be collected)

b. it is necessary to ensure that the target cell completely overlaps with the originating cell (to ensure that the target cell coverage includes the current UE (point) location.

In general, sub-case a is more likely as more cells are likely to partially overlap than completely overlap.

It should be noted that some use cases might employ a “close enough” requirement. For example, a UE in a car maybe traveling sufficiently fast that it predicts a different current location and area based on its current location (and area) and velocity (speed and direction). These applications would use scenario 2 with the modified location parameters.

Several methods can be used to attain the location information. These include:
(i) Delivery.
The UE gets the location of the originating cell base station which either signal its geographical location (as in DVB-SI) and/or its cell id, which can be mapped to geographical information from some other source (e.g. DVB-TPS mapping to DVB-SI or to a URI). The delivery can be either announced (unidirectional signaling from network) or interrogated (bi-directional signaling between UE and network).
(ii) Triangulation.
The location of cell base stations is known, as in (i), and the temporal delay or signal gain (loss) is measured between the UE and at least three base stations and thus it is possible to use trigonometry to estimate the current UE location. This may be achieved for example by monitoring signals from the UMTS base station BS1 shown in FIG. 1 and others (not shown) to carry out the triangulation.
(iii) Positioning.
The GPS circuitry 13 shown in FIG. 2 gives the UE its location.

The method (i) is more suited to scenarios 3 and 4, and methods (ii) and (iii) are more suited to scenarios 1 and 2.

Determining Whether the UE is within the Coverage Area of the Target Cell (Step S6.2)

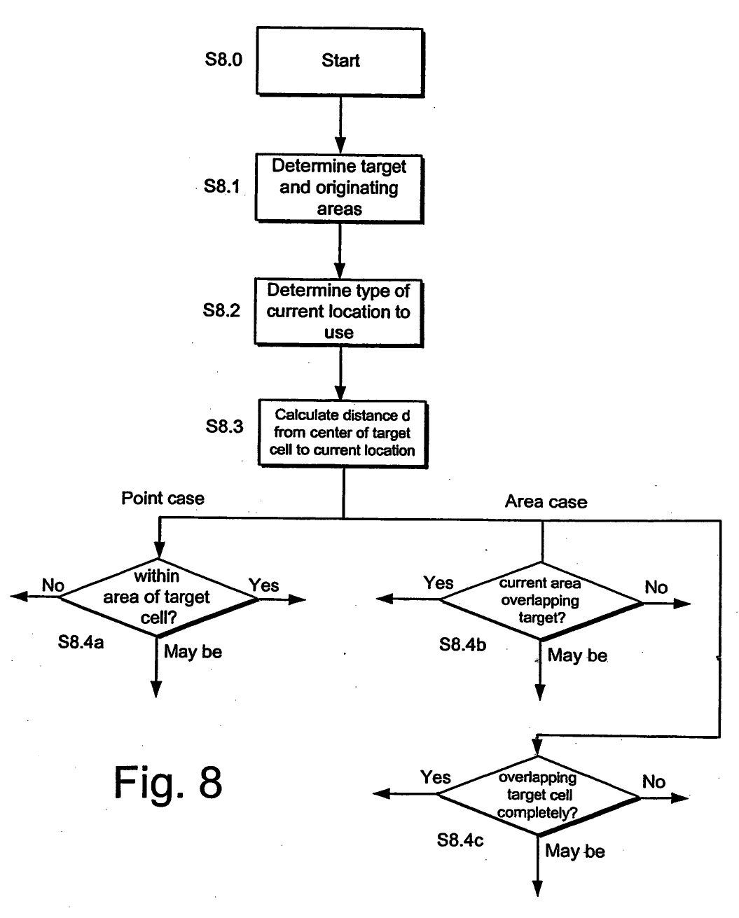

This will now be described for the DVB-T network of FIG. 1 and a schematic flow chart for the process performed by the controller 6 is shown in FIG. 8. In this example, it is assumed that the cell model selection process (step S6.0) has selected the elliptical cell model that comprises the large and small circles L, S although it will be evident hereinafter that the process can be modified if a different cell model has been selected. The outcome of the process can be YES, MAYBE or NO. Also, only one target cell is discussed (i=1), but the algorithm can be iterated at various points for multiple target cells (i=1 . . . n) for situations where the relative merits of handing over to one of a number of target cells needs to be considered.

The process may be performed by the controller 6 of UE1 and commences at step S8.0. The subsequent steps of the process will now be considered in detail.

Step S8.1. Determine the Target and Originating Area Parameters

This information may be derived from the DVB-T NIT data. The data may be converted from angular latitude and longitude data as previously described, into Cartesian frame location information: {mᵢ,nᵢ,aᵢ,bᵢ}. The process is performed for the originating cell (i=0) and the target cell (1=1). Thus,
For i=0,1
   If bᵢ>aᵢ, then lᵢ=bᵢ, Lᵢ=Bᵢ, sᵢ=aᵢ, Sᵢ=Aᵢ,
   else; lᵢ=aᵢ, Lᵢ=Aᵢ, sᵢ=bi, Sᵢ=Bᵢ,
Considering the location of the UE, in scenarios 1 and 3 point case), a₀=b₀=0 i.e. the UE is considered to be at the center of the originating cell, whereas in scenario 2 (UE area case), a₀ may be equal to b₀ and they represent the UE area (not the originating cell)
   Step S8.2. Determine the “Current Location” to Use (mₒ,n₀)
In scenarios 1 and 2, “current location” is the UE location (center point)
In scenarios 3 and 4, “current location” is the originating cell center
   Step S8.3. Calculate the Distance (d) Between the Center of the Target Cell and the Current Location
use Pythagoras: x²+y²=h²,
h is the distance, d
x is the horizontal distance, (m₁-m₀)
y is the vertical distance, (n₁-n₀)

In the point case (scenarios 1 & 3)

Step S8.4a. Is the Current Location within the Area of the Target Cell?

if s₁>d or s₁=d then the result is YES (the point is within the smaller target cell circle)
if l₁<d then the result is NO (the point is not within the larger target cell circle)*
otherwise, the result is MAYBE (the point falls between the two target cell circles)

In the area case (scenarios 2 & 4), sub-case “a” (some overlap—see previous discussion)

Step S8.4b. Is the Current Location Area Overlapping the Area of the Target Cell?

if d<s₁+s₀ then the result is YES (the smaller circles overlap)
if d>l₁+l₀ then the result is NO (the larger circles do not overlap)*
otherwise, the result is MAYBE (the area overlaps with the larger but not the smaller target cell circle)

In the area case (scenarios 2 & 4), sub-case “b” (complete overlap)

Step S8.4c. Is the Current Location Area Completely within the Area of the Target cell?

if s₁>d+l₀ then the result is YES (the smaller originating circle is within the smaller target circle)*
if l₁<d+l₀ then the result is NO (the larger originating circle goes outside the larger target circle)*
otherwise, the result is MAYBE (the area overlaps with the larger but not the smaller target cell circle)

As previously mentioned, this example of the method is specifically for the cell approximation that comprises a small circle and a large circle (L′=L). However, it generally applicable to all alternatives. For instance, the lines marked with an asterix (*) would only need slight modification for the approximation to a small circle and a large rectangle option (L′=R). In this case, each step involving a larger circle would need evaluation again the rectangular parameters instead of the circular (e.g. 2 step analysis of x and y distances as in prior art).

The algorithms can be refined to interchange various parameters (e.g. use s₀ instead of l₀ in step 4) depending on the use case.

The MAYBE result can be ignored or swapped for YES or NO depending on the use case. One embodiment would be to use the MAYBE result to prompt a more detailed calculation (e.g. true elliptical) which occurs less frequently, or over a longer time, than the calculations described above.

Many modifications and variations to the described system are possible. For example, whilst the circles L, S for the cell approximation are concentric in the described examples, they need not be and non concentric circles may more accurately describe cells where filler transmitters are used to enhance cell coverage. Moreover, different cell approximations may be used for inclusion in the cell selection process, and different cell approximations may be used for the originating cell and the target cell. As another example, some embodiments may benefit more from the use of a polar (radius, angle) based co-ordinate system than Cartesian.

1. A method of approximating cell geometry corresponding to a cell coverage area in a cellular transmission system, comprising providing data corresponding to first and second circular parameters for the coverage area of the cell.

2. A method according to claim 1 including providing said data as a function of major and minor axial extents of an ellipse.

3. A method according to claim 1 including providing said data as a function of characteristics of relatively large and small circles.

4. A method according to claim 3 including providing said data as a function of characteristics of relatively large and small circles that are concentric.

5. A method according to claim 3 including providing data corresponding to the centers of the circles.

6. A method according to claim 1 including converting information corresponding to a rectangular approximation of the cell into said data.

7. A method according to claim 6 wherein the rectangular cell information is supplied in terms of latitude and longitude.

8. A method according to claim 7 including converting said information into said data in a different reference frame.

9. A method according to claim 7 wherein the rectangular cell information is supplied by DVB-T SI (Service Information), and including converting said information into a Cartesian reference frame.

10. User equipment for use in a cellular transmission system, comprising a processor configuration to provide data corresponding to first and second circular parameters for the dimensional extent of at least one cell of the system.

11. User equipment according to claim 10 wherein the processor configuration is operable to provide said data as a function of major and minor axial extents of an ellipse.

12. User equipment according to claim 10 wherein the processor configuration is operable to provide said data as a function of characteristics of relatively large and small circles.

13. User equipment according to claim 12 wherein the processor configuration is operable to provide data corresponding to the centers of the circles.

14. User equipment according to claim 10 wherein the processor configuration is operable to convert information corresponding to a rectangular approximation of the cell into said data.

15. User equipment according to claim 14 wherein the rectangular cell information is supplied by DVB-T SI-information, and the processor configuration is operable to convert said information into a Cartesian reference frame.

16. User equipment according to claim 15 comprising a mobile device operable to receive DVB transmissions.

17. User equipment according to claim 16 further operable as telecommunications apparatus.

18. User equipment according to claim 10 including circuitry to provide data corresponding to its current location, and a processor to compare the current location data with the data corresponding to the cell for determining whether a cell handover is to be carried out.

19. User equipment according to claim 10 wherein the processor is operable to select one of a plurality of different approximate geometrical configurations for the cell in dependence on the relationship between the values of said parameters.

20. A cellular transmission network including user equipment, base stations for transmitting signals in a cellular configuration to the user equipment, and a processor configuration to provide data corresponding to first and second circular parameters for the dimensional extent of at least one of the transmission cells provided by the base stations.

21. A method of approximating cell geometry in a cellular transmission system, comprising providing data corresponding to first and second parameters for dimensional extents of the cell, and selecting one of a plurality of different approximate geometrical configurations for the cell in dependence on a relationship that is a function of the values of said parameters.

22. A method according to claim 21 including selecting an approximation of an elliptical cell configuration based on said parameters.

23. A method according to claim 22 including approximating the elliptical cell configuration as relatively large and small circles.

24. A method according to claim 22 including selecting between said elliptical cell configuration and a rectangular cell configuration based on the parameters.

25. User equipment for use in a cellular transmission system, comprising a processor configuration to provide data corresponding to first and second parameters for dimensional extents of the cell, and to select one of a plurality of different approximate geometrical configurations for the cell in dependence on the relationship between the values of said parameters.

26. User equipment according to claim 25 wherein the processor configuration is operable to select an approximation of an elliptical cell configuration based on said parameters.

27. User equipment according to claim 25 wherein the processor configuration is operable to approximate the elliptical cell configuration as relatively large and small circles.

28. User equipment according to claim 25 wherein the processor configuration is operable to select between an elliptical cell configuration and a rectangular cell configuration based on the parameters.

29. User equipment according to claim 25 including circuitry to provide data corresponding to its current location, and a processor to compare the current location data with the data corresponding to the selected cell configuration for determining whether a cell handover is to be carried out.
